(19) United States
(12) Patent Application Publication
(10) Pub. No.: US 2003/0004707 A1
(43) Pub. Date: Jan. 2, 2003

(54) Method and system for structured processing of personal information

(76) Inventor: Fulvio Ferin, Milan (IT)

Correspondence Address: F. Chau & Associates, LLP, Suite 501, 1900 Hempstead Turnpike, East Meadow, NY, 11554, US

(21) Appl. No.: 10/232,926

(22) Filed: Aug. 31, 2002

Related U.S. Application Data
(63) Continuation-in-part of application No. 09/300,993, filed on Apr. 28, 1999.

(30) Foreign Application Priority Data
Dec. 16, 1998 (IT) MI 98A 002700

(51) Int. Cl. G06F 7/00

(52) U.S. Cl. 704/10

(57) ABSTRACT

Systems and methods for structured processing of personal information. In one aspect, computer implemented systems and methods are provided for generating a file of personal information (e.g., curricula vitae) in a proprietary format which is language independent and which ensures the integrity of the stored information. In another aspect, computer implemented systems and methods are provided for processing the proprietary formatted files of personal information.

### CROSS REFERENCE TO RELATED APPLICATIONS

This application is a continuation-in-part of U.S. patent application Ser. No. 09/300,993, filed on Apr. 28, 1999, which claims priority to Italian Application No. MI 98A 002700, filed on Dec. 16, 1998, which applications are fully incorporated herein by reference.

### TECHNICAL FIELD

The present invention generally relates to systems and methods for structured processing of personal information. More specifically, the invention relates to computer implemented systems and methods for generating a file of personal information (e.g., curricula vitae) in a proprietary format which is language independent and which ensures the integrity of the stored information. The invention further relates to computer implemented systems and methods for processing the proprietary formatted files of personal information.

### BACKGROUND

Traditionally, the meeting point between job demand and offer has been based on curricula vitae (or resume). In this connection, certain techniques have been developed to assist a person seeking employment to draft curricula vitae. In addition, techniques have been developed to assist in the collection, organization and selection of such curricula vitae by enterprises, institutions or personnel selection agencies seeking potential candidates. Conventionally, there are three main steps involved in this process. The first step is the traditional paper mailing process, whereby the candidate drafts his/her curriculum in a free, autonomous form, and then sends a copy thereof to either one or more potential employers with whom the candidate may have a particular interest, or to a plurality of potential employers in a mass mailing. For each potential employer, the candidate may have to modify the content of the curriculum itself and/or an accompanying cover letter. Moreover, if the candidate has an international interest, the curriculum vitae must be drafted in, or translated into, one or more foreign languages.

There are several problems associated with this process. For instance, despite the candidate's effort and significant expenditures on economic resources, the candidate may not be able to determine which of the potential employers, if any, considered his/her curricula vitae and entered its content in the employers' database. Furthermore, the curricula vitae may not contain—even purposely—the information required by, or necessary for, the personnel selectioner to perform a proper evaluation of the candidate.

The second step in the conventional process begins when a target company receives the candidate's curricula vitae as well as a plurality of other of paper documents from other potential candidates, and then proceeds to select candidates whom the company wants to either interview or obtain additional information from (which is typically a small percentage of candidates). The selection process is typically based on priority criteria established on a case-by-case basis. However, the selection process between the various resumes is difficult due to the liberty and subjectiveness of the persons that initially review the resumes.

For this reason, most companies and, particularly, the personnel selection agencies proceed to create and maintain a candidate database, which is the third step in the conventional process. In this process, the companies may codify certain information, for instance, educational qualification, profession, and economic area, etc., and manually input the corresponding information (taken from selected resumes) in the database. The manual entry process, however, may be costly and is subject to errors in the input information. Consequently, companies typically limit the amount and type of information that will be extracted from each resume and entered in the database. Unfortunately, this limits the search criteria that can be used for database queries when searching for potential candidates, which actually leads to higher costs in the selection process.

One conventional solution to address the problems associated with manual database entry involves scanning the resumes using optical character recognition techniques, and then creating various “keywords” which are used for querying the database. The basic problem remains that not all resumes contain the information relevant for the company. Therefore, the company is compelled to contact the potential candidates to supplement their resumes with the missing information, a factor which adds to the already relevant costs. From the point of view of the perspective employee, this solution offers no advantage.

Other conventional solutions to manual database entry are based on the increasing diffusion of information networks such as the Internet. For instance, the well-known CV-BUILDER system, which is widespread mainly in the U.S.A., consists essentially of forms which are completed “on-line” at web sites of the participating companies. There are several advantages with this method from the standpoint of the companies. First, the costs decrease because manual entry in the database is avoided. In addition, since the “on-line” form is specifically developed for the company, the essential selection criteria is already present and codified in a searchable format.

This “on-line” method, however, does have several disadvantages. For instance, data entry in forms via the Internet is rather slow, and the formats of the forms of the various companies are not standardized. In particular, each form proposes questions according to a proprietary plan, which the candidate must understand before inputting his/her answers. In addition, the telephone connection cost to the potential candidate may exceed the costs for a postal mailing. Moreover, for each new company the form has to be filled-in ex novo. Another disadvantage is that the “on-line” data entry may be interrupted or temporarily suspended due to, e.g., a telephone line disconnection, so that there is the risk of having to start again.

Another relevant aspect, not satisfactorily solved by any of the above proposed solutions, are the laws regarding personal data handling, which impose on database managers the obligation to guarantee the accuracy of the personal information and the obligation to obtain consent for use of the personal information.

### SUMMARY

The present invention is generally directed to systems and methods for structured processing of personal information. More specifically, the invention is directed to computer implemented systems and methods for generating a file of personal information (e.g., curricula vitae) in a proprietary format which is language independent and which ensures the integrity of the stored information, as well as computer implemented systems and methods for processing the proprietary formatted files of personal information.

In one aspect of the invention, a method for structured processing of personal information comprises the steps of presenting a user interface to a user for inputting personal information, the user interface comprising at least one coded field that is associated with a plurality of predefined codified items that can be selected by the user to input personal information, the predefined codified items being defined in a dictionary, and generating a proprietary formatted file of personal information comprising a digital codification of personal information input in a coded field that is generated using the dictionary, wherein the digital codification of the personal information provides a representation of the input personal information in a language independent format.

In another aspect, a user interface comprises a GUI (graphic user interface) to display at least one data entry mask comprising a plurality of predetermined data entry fields including coded fields.

In yet another aspect, the step of generating a proprietary formatted file comprises accessing a dictionary comprising a predetermined set of codified items and a mapping of codes to the codified items, and assigning a predetermined code to a codified item of personal information that is selected in a coded field by the user. In a preferred embodiment, a dictionary defines a set of codified items that are associated with coded fields and objects for a user interface and a mapping of the interdependence between codes, codified items and objects in a plurality of languages

In another aspect of the invention, a file of personal information is encrypted the file using an encryption protocol that uses a private key to protect the content of the file from being modified by a user without knowledge of the private key, and that uses a public key to enable public reading and processing, but not modification, of the content of the file by a user having knowledge of the public key.

In yet another aspect of the invention, the content of a proprietary formatted file of personal information is automatically imported in a database of at least one corresponding remote processing system capable of processing the proprietary format of the file. A database search for desired personal information stored in the database is performed using digital codifications of input queries that correspond to digital codifications of the input information. More specifically, in one embodiment, the searching process comprises displaying query masks comprising data entry fields corresponding to the data fields of the input data entry masks, inputting at least one query parameter using the displayed query masks, generating a corresponding digital codification of the input query parameters in a language-independent format, selecting one or more stored file from the database in accordance with logical relations between the digital codification of the stored file and the digital codification of the query parameters, and then displaying selected files to the user, wherein the digital codification of the inputs of a selected file are displayed in the corresponding data fields of the query mask.

The present invention overcomes the above noted disadvantages of conventional systems by allowing a user to create curricula vitae exhaustive from an information standpoint based on a predetermined information structure which is compatible with one or more subscribing remote information processing systems of, e.g., potential employers such that virtually all the personal information is readily available for processing by aimed query.

These and other aspects, features and advantages of the present system and method will become apparent from the following detailed description of preferred embodiments, which is to be read in connection with the accompanying drawings.

### BRIEF DESCRIPTION OF THE DRAWINGS

FIG. 1 is a block diagram which illustrates a system for structured processing of personal information according to an embodiment of the present invention;

FIG. 2 is a diagram of an exemplary data entry mask which may be used in the system of FIG. 1 in accordance with one aspect of the present invention; and

FIGS. 3A and 3B illustrate a flow diagram of a method for structured processing of personal information in accordance with one aspect of the present invention.

### DETAILED DESCRIPTION OF PREFERRED EMBODIMENTS

The present invention generally relates to systems and methods for structured processing of personal information. More specifically, the invention relates to computer implemented systems and methods for generating a file of personal information (e.g., curricula vitae) in a proprietary format which is language independent and which ensures the integrity of the stored information. The invention further relates to computer implemented systems and methods for processing the proprietary formatted files of personal information.

It is to be further understood that the systems and methods described herein in accordance with the present invention may be implemented in various forms of hardware, software, firmware, special purpose processors, or a combination thereof. Preferably, the systems and methods described herein are implemented in software as an application comprising program instructions that are tangibly embodied on one or more program storage devices (e.g., magnetic floppy disk, RAM, CD ROM, ROM and Flash memory), and executable by any device or machine comprising a suitable architecture. Further, since the constituent system modules and method steps depicted in the accompanying Figures are preferably implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

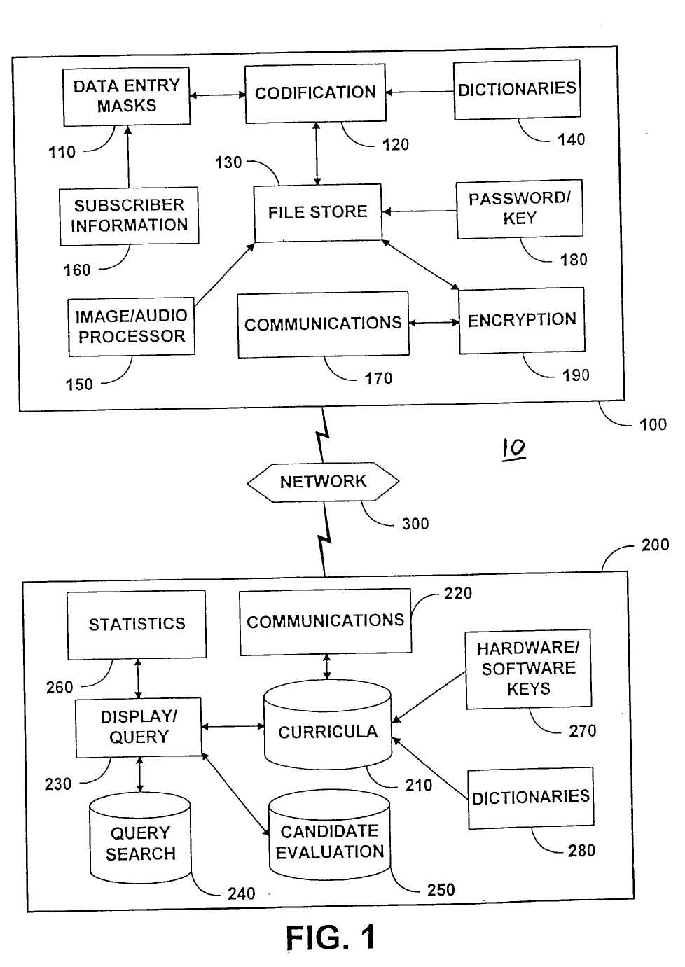

Referring now to FIG. 1, a block diagram illustrates a system 10 for structured processing of personal information according to an embodiment of the present invention. In general, the system 10 comprises a separate generating subsystem 100 and processing subsystem 200. The generating subsystem 100 allows a user to generate a file of personal information (e.g., resume) in a proprietary format which is language independent and which ensures the integrity of the stored information. The processing subsystem 200 is a system that is capable of processing the proprietary formatted files of personal information, as well as managing and using the personal information contained in such files. For example, the processing subsystem 100 may be used by companies specialized in personnel selection (i.e., “head-hunters”), as well as companies interested in personally handling and maintaining a database of perspective employees and/or of their own staff.

It is to be appreciated that the system 10 according to a preferred embodiment of the invention comprises an “Off-line” system, wherein the generating subsystem 100 and the processing subsystem 200 are independent such that either system can be independently and separately used without having to establish communication between the systems (which is to be contrasted with conventional “on-line” systems). Indeed, the transmission of a proprietary formatted file of personal information from the generating subsystem 100 to the processing subsystem 200 can be performed using any appropriate mode of communication such as, for example, transferring the files electronically (e.g., via the Internet) or mailing a floppy disk containing a file to one or more desired recipients having a processing subsystem 200.

Advantageously, asynchronous communication between the generating and processing subsystems 100, 200 affords considerable advantages of implementation including, for example, the reduction of infrastructure costs. Further, the “Off-line” framework of the system 10 allows a user of the generating subsystem 100 to generate a single file of personal information, and then send the same file to a plurality of recipients having an associated processing subsystem 200 (e.g., a candidate employee can send the same resume to many potential employers). This is to be contrasted with conventional “On-line” systems, where, for example, the user must log in to each individual web site of desired employers and proceed with filling different GUI forms at each site, which is a tedious task and can be extremely burdensome to the user.

It is to be appreciated that the generating subsystem 100 and the processing subsystem 200 may communicate via any suitable information network 300 including, but not limited to, an IP-based network, a wireless network and/or PSTN (public switched telephone network), using known communication protocols. Although the exemplary system 10 of FIG. 1 depicts a single generating and processing subsystem for illustrative purposes, it is to be understood that the system 10 may comprise any number of generating and processing subsystems.

The generating subsystem 100 includes a user interface module 110 for, e.g., rendering and displaying suitable GUIs (graphical user interfaces) to display one or more data entry masks 110. It is to be understood that speech and/or GUI user interfaces may be used, wherein, for example, the input modality for inputting personal information in the generating subsystem can be speech-based and/or GUI-based. The exemplary embodiments described herein should not be construed as any limitation of the invention. Each data entry mask 110 comprises one or more input data fields that allow the user to input corresponding information. The data entry masks 110 comprise various types of input fields including input fields for free text, input fields for format-specific strings such as dates, and input fields that allow a user to select items from a list (e.g., a pull down list of menu items). The input fields whose value can be selected among of set of predetermined values (e.g., a list of degrees or a list of professions) are referred to herein as “coded input fields” (or “coded fields”). The data (or values) that can be input (selected) in coded fields by a user during a data mask entry process are digitally codified via codification module 120 based on a predetermined set of codified items as defined in one or more dictionaries in dictionary database 140 (or DLD (digital language dictionary)), and then stored in a proprietary formatted file in memory 130.

More specifically, the dictionaries 140 comprise a collection of all codified items that are used to represent information or objects. The dictionaries 140 comprise maps for associating related codes and codified items and/or associating related objects and codified items. In a preferred embodiment, the dictionaries 140 provide a mapping of the interdependence between the codes, objects and codified items, in different languages such as English, Italian, French, and/or Spanish, etc. The dictionaries 140 provide a mechanism for performing digital codification/decodification according to the invention, which enables files of personal information to be stored and processed in a language independent format. A digital codification process according to an embodiment of the invention, which uses dictionaries in database 140, provides a mechanism for presenting in various languages, a UI (user interface) and lists of predetermined values for coded fields, for example, wherein related codes for coded fields and UI objects are logically mapped in different languages. A “digital codification” process generally refers to a process of associating a codified item in a dictionary with a predetermined code. In a similar manner, digital decodification generally refers to a process of associating a predetermined code with a corresponding codified item in a dictionary.

The following examples illustrate methods for codification/decodification according to embodiments of the invention. In one embodiment, digital codification is applied to personal information that is input in coded fields. For example, using a related English dictionary, if the value “male” is selected by a user for the coded field “sex”, a digital codification process will assign a predetermined code value for the input value for the coded field “sex”. In a corresponding Italian dictionary, the value “maschio” (“male”) will be associated with the same predetermined code value in the related English dictionary.

More specifically, in the dictionary database, a coded input field for the term “sex” (attribute) would be defined as having two possible entries (values), “male” and “female”, with each value being assigned a code in different languages as follows:

For an English dictionary, the mapping is as follows:

“male”⇄code=1; and

“female”⇄code=2,

and the mapping for the corresponding Italian dictionary is:

“maschio”⇄code=1; and

“Femmina”⇄code=2.

Therefore, when a user is generating a file of personal information using a processing subsystem comprising the above exemplary dictionary, if a user selects “male” in a “sex” coded field, a digital codification process would generate a file of personal information comprising a code value of “1” as the value for “sex” information. When printing the content of such file, for example, a digital decodification process would associate the code value of “1” to the codified item assigned to that code (male) in a desired language.

In another embodiment, digital codification is applied for mapping related terms and objects, which allows, for example, objects for a GUI to be rendered in different languages. By way of example, an object for a UI may have a descriptive text caption. In particular, consider a “push button” that is displayed to allow a user to access an on-line software guide (help function), a dictionary that defines the push button object may comprise the following mapping:

English: “Help”⇄code=Id Button Help; and

Italian: “Aiuto”⇄code=Id Button Help.

As is evident, there are many advantages associated with dictionaries and digital codification using the dictionaries. As demonstrated above, digital codification and the dictionaries enable multi-language use of the generating and processing subsystems. Indeed, through a digital codification process, the user can input personal information in coded fields (of selectable items) of one or more data entry masks (in a generating subsystem 100) to generate a file of personal information in a language independent format. A user can create a file of personal information using an English language GUI, for example, and then print his/her file of personal information in one or more different languages. Further, the user's file, which was generated in a particular language, can be “consulted” in a different language (wherein the term “consulted” refers to, e.g., a database search, reading personal information, and otherwise processing the personal information). No translation is required between different languages.

Further, the dictionaries provide a mechanism for presenting the user interface objects including data entry masks (e.g., the coded fields and corresponding selectable items) in different languages. The dictionaries may further provide a mechanism for providing answers to most frequently asked questions and a series of quick tips to assist a user seeking help while using the generating subsystem 100, for example.

Another advantage associated with the use of dictionaries is that a predetermined set of codified terms/items provides a means for information standardization. In a preferred embodiment, the dictionaries are designed with a view towards achieving equivalence between the information values associated with various countries/cultures. For instance, the various components that constitute “academic training” can vary between different countries/cultures. But in accordance with the invention, the term “academic training” can be codified in dictionaries based on a standard that generally/collectively describes the different education and/or schooling frameworks and academic levels associated with “academic training” for various countries/cultures. It is to be appreciated that the amount of codified items in dictionaries may be several thousand, and, by way of example, divided in the following main sections: (i) educational qualifications; (ii) economic activities; (iii) job qualifications; (iv) organizative units; and (v) levels of knowledge of foreign languages. In the dictionaries, the codified items that are associated with “economic activities” and the “job qualifications” can be classified in a standardized manner using, for example, the main relevant international classifications.

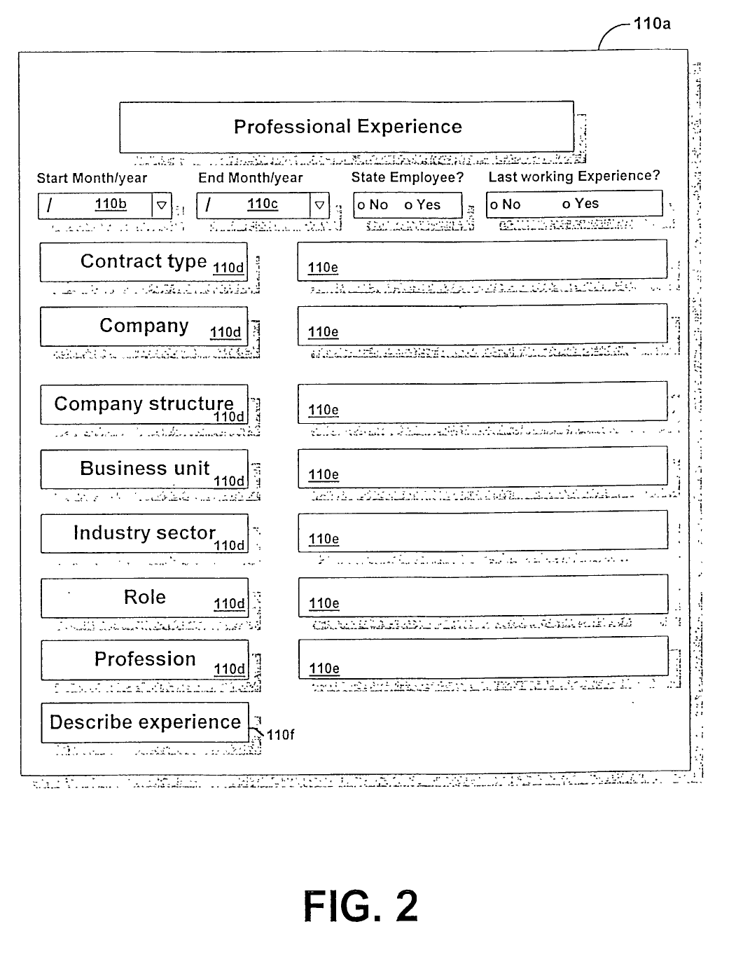

FIG. 2 is an exemplary diagram of a data entry mask 110a that can be displayed to a user for inputting information associated with “Professional Experience” (previous employment) of the user when generating a file of personal information, such as a resume. More specifically, for each previous employment of the user, the exemplary data entry mask 110a can be used to input information such as the beginning/termination dates of employment via a “Start” date field 110b and an “End” date field 110c. In addition, the user can select one or more of various headings 110d, which are preferably coded fields having selectable items (e.g., pull-down menu), for inputting personal information related to each heading 110d. A summary of the input information (e.g., selected items) for each heading 110d can be displayed in a corresponding display field 110e. In addition, the data entry mask 110a may include a heading 110f that allows the candidate to input a free-text description of his experience with the company.

It is to be appreciated that the exemplary data entry mask 110a enables a candidate to provide, in some standard fashion, the relevant information for each company, and organizative unit within the company, where the candidate's experience was made. In one embodiment, the data entry mask 110a allows a user to provide information such as typical personnel and general information such as size, ownership, place of business, as well as the company's functional structure (e.g., functional, divisional, matrix-type, etc.).

Further, in one exemplary embodiment of the invention, the organizative unit within the company may be codified based on: (1) the economic activity of the organizative unit; (2) the indirect weight of the candidate's position within the unit; (3) the working areas and the relative contexts with respect to the economic activity of the organizative unit, with an indication of the path of organizative development in terms of acquired competence; (4) the geographic width of the acquired responsibilities; and (5) the employment title within the organizative unit.

FIG. 2 is an exemplary illustration of the richness and breadth of information that can be acquired using a generating subsystem 100 according to the invention. FIG. 2 is exemplary of a data entry mask that may be used for generating a curriculum vitae. It is to be appreciated that other data masks that may be used for generating a curriculum vitae include masks for inputting personal data, studies, known languages, career, etc.

In a preferred embodiment, mechanisms are employed to enable personal information to be acquired in a context-sensitive manner. For example, the content of a data entry mask can be either dynamically modified based on the given context in which the file is generated. Further, different data masks may be displayed to a user based on the given context. By way of example, assume a candidate is seeking his/her first job and has no history of previous employment. Such a priori information can be used by the system to display data entry masks for generating a resume, without having to display a mask for “previous employment”. In addition, for each company, items that correspond to activities that are typically found in similar companies can be presented to the-user in appropriate item selection fields. The generating subsystem is preferably configured to display relevant data entry masks that allow a candidate to draft a superior quality curriculum that contains all information necessary for a given personnel selection company.

Referring again to FIG. 1, the generating subsystem 100 may also include an image/audio processing module 150 that allows a user to, e.g., process a digital photograph (e.g., scanning a photograph, or directly by a digital camera) or a multimedia (video and/or audio) file and attach an audio and/or image file to the user's file of personal information. In this manner, the user can provide further information of interest.

The generating subsystem 100 maintains subscriber information 160, which comprises an “Address Book” that preferably lists the addresses (mailing address, URL, etc.) and other contact information for each participating/subscribing company or web site having a processing subsystem 200 that is capable of processing a proprietary formatted file of personal information. The address book listing allows a user to select one or more potential recipients of the user's file of personal information, while being assured that the user's personal information will be handled appropriately by the recipients in accordance with specific modalities as described herein (e.g., original information integrity, language independence, automatic database input, etc.).

As another example for dynamically generating the content of data masks, it is to be appreciated that the subscriber information 160 associated with a given company may be used by data entry mask module 110 to modify the content of a default set of data entry masks and display data entry masks having input data fields that are specific for the given company. This mechanism allows the subscribing companies to in effect “personalize” the data entry masks that are displayed to the user to obtain particular information. For instance, a given company may want the user to specify the reason for sending the file of personal information (e.g., reference to an advertisement, spontaneous forwarding, etc.). Further, a specific data entry mask for a given company may display information that enables a user to determine, e.g., whether accompanying digital images or multimedia files are acceptable, or the minimum requirements for sending a resume.

The generating subsystem 100 can establish a connection to the information network 300 (e.g. Internet) using communications module 170, which comprises any suitable communication stack for providing coding, transport and control of data files for communication over a network. A user can electronically forward a file of personal information to one or more processing subsystems 200 connected to the network 300. In one embodiment, this forwarding process can be performed automatically by selecting an e-mail address or URL from the Address Book in subscriber information module 160. Further, the communications module 170 enables a user to establish communication with a server in network 300 to periodically download updated subscriber information. In another embodiment, the generating subsystem 100 is configured to automatically generate and maintain a transmission log which, e.g., records information such as the date and time that a file of personal information is electronically mailed to a recipient via the information network 300, as well as the location/identity/address of the recipient. In another embodiment, the transmission log can be edited by the user to record the times and dates and locations of regular mailings.

As noted above, each file of personal information is stored in a proprietary format, which comprises a digital codification of the input personal information, and possibly attached files (e.g., image, audio, video files, etc.) and other information, stored in a single container. Preferably, a proprietary format according to the invention enables “private writing” and “public reading” of a file of personal information such that the content of the file can only be modified by the author and such that the content of a file can only be read and processed by an authorized recipient. In a preferred embodiment, a file of personal information is protected through a password/key 180 and a data encryption process 190. Any suitable encryption process (e.g., public key/private key encoding protocol) can be employed by encryption module 190 to encode a file of personal information that is either stored in a user's personal directory, or forwarded via the information network 300 to one or more desired addresses. The encryption process prevents the content of a proprietary formatted file from being modified by an unauthorized individual without knowledge of the private key/password. Presumably, only the owner of the personal information will know the corresponding key/password and be able to modify the content of a proprietary formatted file of personal information.

In addition, the encryption protocol enables decryption of a file of personal information by those companies possessing a corresponding processing subsystem 200, wherein the reading and processing of the personal information in a proprietary formatted file of personal information is permitted only by certified users of a processing subsystem 200, but wherein such certified users cannot modify the content of such file. In this manner, a recipient of personal information who possesses a proprietary formatted file can guarantee the originality of the information contained in the file.

The use of an encryption framework that enables “public reading and private writing” is very important for privacy regulations. Advantageously, the recipient of a proprietary formatted file of personal information according to the invention enables a recipient of the file to guarantee that the original information is preserved. Further, the proprietary format provides an explicit authorization to the recipient of the file to handle the personal information and such authorization cannot be modified by the information user. In other words, possession of a file in a proprietary format according to the invention essentially discharges the obligation on part of the recipient of the file to have the owner of the file sign an authorization for handling/using the data contained in the file.

For further security and discretion, the generating subsystem 100 may also be programmed such that the subsystem 100 can be executed on a host system/device without requiring installation, e.g., to be used in such a mode as to leave no trace of its execution in a personal computer because it does not create any permanent file.

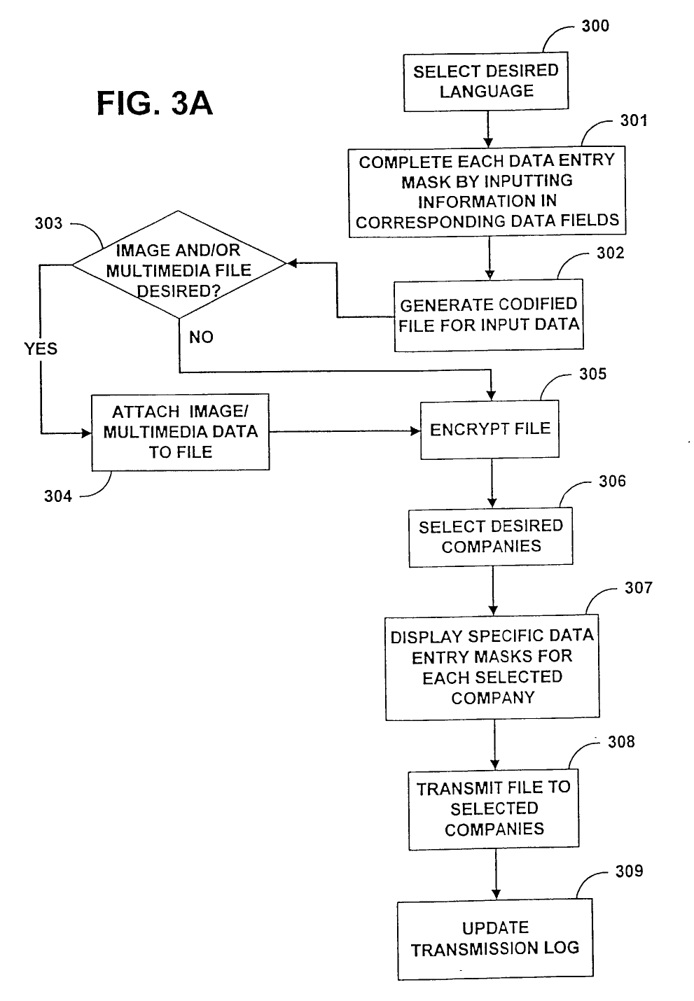

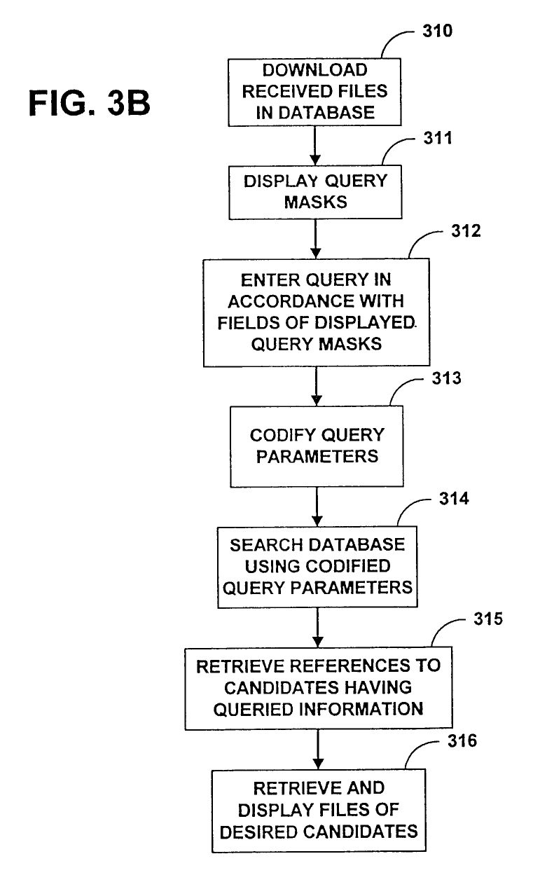

Referring now to FIG. 3A, a flow diagram illustrates a method for generating a file of personal information (such as a resume) using the generating subsystem 100, in accordance with one aspect of the present invention. Initially, the user may select a language from a list of available languages (step 300) so that the user can read the displayed text of the data fields and the selectable data entry items in a desired language. Next, the generating subsystem 100 will display each of the data entry masks (one at a time) and the user will complete each data entry mask by entering his/her personal information in the data fields associated with each data entry mask (step 301). The input data will then be subject to a digital codification process as discussed above and stored in a file (step 302).

If the user desires to attach a digital image of him/her and/or a multimedia file to provide additional information (affirmative decision in step 303), the image and/or multimedia data can be attached to the file (step 304). Next, the file of personal information comprising the digitally codified personal information and image/multimedia data will be encrypted using a proprietary encryption key (step 305). The user may then select (from the list of subscribing companies) each company the user desires to send his/her resume (step 306). Then, data entry masks which are specific to one or more of the selected companies may be displayed (step 307), which allows the user to input specific information requested by a given selected company (e.g., whether the resume is being sent in response to an advertisement, etc.). The encrypted file may then be transmitted to each of the selected companies via the information network (step 308). Alternatively, as discussed above, the encrypted file may be stored one or more magnetic floppy disks and mailed to the desired companies. Then, as discussed above, the stored transmission log may be automatically updated (step 309).

Referring again to FIG. 1, a detailed description of preferred embodiments of a processing subsystem according to the invention will now be discussed. A processing subsystem 200 (which is utilized by, e.g., personnel selecting users) comprises a database 210 for storing a proprietary formatted file of personal information (resume) generated by the generating subsystem 100. The processing subsystem 200 is configured to automatically enter the personal information contained in a proprietary formatted file into the database 210. In a preferred embodiment, the processing subsystem 200 can downloaded a file of personal information from the information network 300 via a communications module 220 similar to that discussed above. With this method, it is to be appreciated that the costs for downloading and entering the file content into database 210 is minimal. In this respect, it should be emphasized that the preferred process of utilizing the information network 300 to transmit and receive the proprietary formatted files of personal information is wholly autonomous since a so-called “browser” of electronic mail is not required.

Alternatively, a file of personal information can be stored on a magnetic disk and mailed by the user to a desired company, wherein the file content is retrieved from the disk and entered in the database of the company's processing subsystem. Even when the forwarding occurs by means of floppy disks or other data support, however, the loading cost is very minimal because no digitizing and scanning methods or manual input and control operations are necessary.

Advantageously, as noted above, the use of the information network 300 by a candidate to forward a resume offers various advantages. One advantage is that via a single telephone call, the candidate may simultaneously transmit his/her resume to various companies. In addition, the candidate can automatically receive confirmation that the candidate's resume was input in a curriculum database 210 of a given company. Moreover, the candidate may periodically transmit updates of his/her resume to the same recipients to update the candidate's personal information stored in the recipient's database 210. In addition, the candidate may transmit a request that his/her personal information be deleted from the recipient's database 210. Accordingly, it is to be appreciated that the present invention eliminates the burden of conventional methods regarding “on-line” completion of forms, namely, the candidate is not restricted to complete the curriculum in one step during a telephone connection, but he may proceed “off-line” and save, load and edit more versions of his/her own curriculum in several steps.

The processing subsystem 200 further comprises a display/query module 230 for displaying masks that are analogous to those described above with respect to the generating subsystem, but which serve to input query parameters. The display/query module 230 comprises a suitable database query engine which can operate on the digitally codified information of a proprietary formatted file (e.g., educational qualifications, the profession, the organizative position, the experience, the field, the economic activity of the company etc.) that is stored in database 210. The display/query module 230 is also configured for searching the database 210 using keywords to, e.g., search for candidates having worked in a specified company, and then displaying retrieved data in the form of tables containing data from various selected curricula. The display/query module 230 may also be configured to allow the user to store a specific search strategy in a query search database 240 so that a previously generated search query can selected and used again, or possibly modified. The display/query module 230 may also be configured to allow the user to store the names of all potential candidates in candidate evaluation store 250 who are personally interviewed within the frame of a selection, as well as attaching some evaluation arrived at during such interviews by introducing personalized evaluation criteria. Advantageously, for each sought position, the personnel selection company may obtain, from a suitable statistic module 260, data such as statistic remuneration parameters, an analysis of the mean remuneration with respect to age, economic field, profession etc., the number of the candidates having replied to each specific advertising, the number of the candidates deemed interesting, the number of those interviewed and hired, etc.

The processing subsystem 200 is preferably protected by a hardware key and a software key 270 which are used for interpreting the curriculum proprietary format of the present invention and decrypting the curricula received via information network 300. Security is achieved by maintaining the personal information of each candidate in encrypted form in database 210. The access and decrypt keys comprise the software key which is only known to the person responsible of data security in the company, and a hardware key which is factory wired. Therefore, in the event that the physical supports were removed, it would be virtually impossible for an unauthorized third person to interpret the content of database 210 without possessing both the keys (i.e., hardware and software). In addition, by configuring the generating subsystem 100 to prompt the candidate employees to provide information regarding personal data handling and obtain any required consent, the receiving company may acquire, in the format of the curriculum itself, the candidate's consent to the specific use of his/her personal data.

The processing subsystem 200 comprises a dictionary database 280 having dictionaries similar to the dictionaries 140 of the generating subsystem. The dictionaries 280 enable digital “decodification” of a digitally codified file of personal information, whereby a certified user of the processing subsystem 200 can process the received information in any desired language. For instance, a curriculum drafted in Italian might be displayed, queried and/or printed in another language such as in English by the processing subsystem 200 using dictionaries in database 280.

It is to be appreciated that the curriculum database 210, which is generated and managed via the processing subsystem 200, further allows curricula to be imported from other compatible databases (e.g., databases of other processing subsystems). Accordingly, a user may load curricula stored at remote locations, as well as clear export, namely, in not-codified form, towards any other (e.g., incompatible) processing system.

Referring now to FIG. 3B, a flow diagram illustrates a method for information retrieval which may be implemented in the processing subsystem 200. In order to search the database, the files received by users of the generating subsystem 100 are imported into the database (step 310). A query search mode is selected by the user to display one or more query masks (step 311). The user then inputs desired query parameters in the fields of the displayed query masks (step 312). The query parameters are subject to a digital codification whereby the input items (query parameters) are mapped to the predefined codes that are assigned to a related codified item in a dictionary and the codes are used to search for files of personal information comprising similar codes (step 313). The database is searched using the codified query parameters by, e.g., finding one or more stored files having a code that matches a code of a query parameter (step 314). The query engine will retrieve from the database references to candidates whose files comprise the queried information (step 315). If desired, the user may view the files associated with one or more of the retrieved references by retrieving the desired files from the database 210, decrypting the files, and displaying the files in any desired language (316).

Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for structured processing of personal information, comprising the steps of:
presenting a user interface to a user for inputting personal information, the user interface comprising at least one coded field that is associated with a plurality of predefined codified items that can be selected by the user to input personal information, the predefined codified items being defined in a dictionary; and
generating a proprietary formatted file of personal information comprising a digital codification of personal information input in a coded field that is generated using the dictionary, wherein the digital codification of the personal information provides a representation of the input personal information in a language independent format.

2. The method of claim 1, wherein the step of generating a proprietary formatted file comprises the steps of:
accessing a dictionary, the dictionary comprising a predetermined set of codified items and a mapping of codes to the codified items; and
assigning a predetermined code to a codified item of personal information that is selected in a coded field by the user.

3. The method of claim 1, further comprising the step of generating a dictionary that defines a set of codified items that are associated with coded fields and objects for a user interface.

4. The method of claim 3, wherein the step of generating the dictionary comprises the step of mapping an interdependence between codes, codified items and objects in a plurality of languages.

5. The method of claim 4, further comprising the step of displaying selectable items of a coded field in one of a plurality of different languages using the dictionary.

6. The method of claim 1, wherein the step of presenting a user interface comprises presenting a GUI (graphic user interface) to display at least one data entry mask comprising a plurality of predetermined data entry fields including coded fields.

7. The method of claim 6, wherein the data entry masks and corresponding data entry fields are dynamically rendered for presentation to the user in a context sensitive manner.

8. The method of claim 1, wherein the step of generating the proprietary formatted file of personal information comprises the step of encrypting the file using an encryption protocol that uses a private key to protect the content of the file from being modified by a user without knowledge of the private key, and that uses a public key to enable public reading and processing, but not modification, of the content of the file by a user having knowledge of the public key.

9. The method of claim 1, further comprising the steps of:
automatically importing the content of the proprietary formatted file in a database of at least one corresponding remote processing system capable of processing the proprietary format of the file; and
searching for desired personal information stored in the database using digital codifications of input queries that correspond to digital codifications of the input information.

10. The method of claim 9, wherein the step of searching comprises the step of displaying query masks comprising data entry fields corresponding to the data fields of the input data entry masks.

11. The method of claim 10, wherein the searching step comprises the steps of:
inputting at least one query parameter using the displayed query masks;
generating a corresponding digital codification of the at least one input query parameter in a language-independent format;
selecting at least one stored file from the database in accordance with logical relations between the digital codification of the stored file and the digital codification of the at least one query parameter; and
displaying the at least one selected file, wherein the digital codification of the inputs of the at least one selected file are displayed in the corresponding data fields of the query mask.

12. The method of claim 9, further comprising the step of electronically transmitting the proprietary formatted file to the database over a communications network.

13. The method of claim 1, further comprising the step of processing one of a multimedia file, a digital image, and a combination thereof, and including the processed file in the proprietary formatted file.

14. The method of claim 9, wherein the step of inputting personal information includes the steps of:
selecting, from a stored list, one of a single and plurality of personnel selection users having the corresponding processing system to which a file is to be sent; and
displaying, for each selected personnel selection user, at least on data entry mask having fields which are specific to the personnel selection user.

15. The method of claim 14, further comprising the step of periodically downloading updates for the stored list from a server over the communications network.

16. The method of claim 9, further comprising the step of generating a transmission log comprising information for each remote processing system to which the file was sent.

17. A program storage device readable by a machine, the program storage device tangibly embodying a program of instructions executable by the machines to perform method steps for structured processing of personal information, the method steps comprising:
presenting a user interface to a user for inputting personal information, the user interface comprising at least one coded field that is associated with a plurality of predefined codified items that can be selected by the user to input personal information, the predefined codified items being defined in a dictionary; and
generating a proprietary formatted file of personal information comprising a digital codification of personal information input in a coded field that is generated using the dictionary, wherein the digital codification of the personal information provides a representation of the input personal information in a language independent format.

18. The program storage device of claim 17, wherein the instructions for performing the step of generating a proprietary formatted file comprise instructions for performing the steps of:
accessing a dictionary, the dictionary comprising a predetermined set of codified items and a mapping of codes to the codified items; and
assigning a predetermined code to a codified item of personal information that is selected in a coded field by the user.

19. The program storage device of claim 17, further comprising instructions for performing the step of generating a dictionary that defines a set of codified items that are associated with coded fields and objects for a user interface.

20. The program storage device of claim 19, wherein the instructions for generating the dictionary comprise instructions for performing the step of mapping an interdependence between codes, codified items and objects in a plurality of languages.

21. The program storage device of claim 20, further comprising instructions for performing the step of displaying selectable items of a coded field in one of a plurality of different languages using the dictionary.

22. The program storage device of claim 17, wherein the instructions for performing the step of presenting a user interface comprise instructions for presenting a GUI (graphic user interface) to display at least one data entry mask comprising a plurality of predetermined data entry fields including coded fields.

23. The program storage device of claim 22, further comprising instructions for dynamically rendering the data entry masks and corresponding data entry fields for presentation to the user in a context sensitive manner.

24. The program storage device of claim 17, wherein the instructions for performing the step of generating the proprietary formatted file of personal information comprise instructions for performing the step of encrypting the file using an encryption protocol that uses a private key to protect the content of the file from being modified by a user without knowledge of the private key, and that uses a public key to enable public reading and processing, but not modification, of the content of the file by a user having knowledge of the public key.

25. The program storage device of claim 17, further comprising instructions for performing the step of processing one of a multimedia file, a digital image, and a combination thereof, and including the processed file in the proprietary formatted file.

26. The program storage device of claim 17, further comprising instructions for performing the steps of transmitting the proprietary formatted file over a communications network to a database of at least one corresponding remote processing system capable of processing the proprietary format of the file, wherein the content of the proprietary formatted file is automatically imported in the database.

27. The program storage device of claim 26, wherein the instructions for performing the step of inputting personal information comprises instructions for performing the steps of:
selecting, from a stored list, one of a single and plurality of personnel selection users having the corresponding processing system to which a file is to be sent; and
displaying, for each selected personnel selection user, at least on data entry mask having fields which are specific to the personnel selection user.

28. The program storage device of claim 27, further comprising instructions for performing the step of periodically downloading updates for the stored list from a server over the communications network.

29. The program storage device of claim 26, further comprising instructions for performing the step of generating a transmission log comprising information for each remote processing system to which the file was sent.

30. A system for providing structured processing of personal information, comprising:
at least one generating system comprising:
means for presenting a user interface to a user for inputting personal information, the user interface comprising at least one coded field that is associated with a plurality of predefined codified items that can be selected by the user to input personal information, the predefined codified items being defined in a dictionary; and
means for generating a proprietary formatted file of personal information comprising a digital codification of personal information input in a coded field that is generated using the dictionary, wherein the digital codification of the personal information provides a representation of the input personal information in a language independent format; and
at least one processing system comprising;
means for automatically importing the content of the proprietary formatted file in a database of at least one corresponding remote processing system capable of processing the proprietary format of the file; and
means for searching for desired personal information stored in the database using digital codifications of input queries that correspond to digital codifications of the input information.
